(19) United States
(12) Patent Application Publication
(10) Pub. No.: US 2020/0045891 A1
(43) Pub. Date: Feb. 13, 2020

(54) PULSED LIGHTING CONTROLLER

(71) Applicant: PLANT EPIGENETICS INC., Edmonton (CA)

(72) Inventors: Aaron Stuart Frame, Kelowna (CA); Ross Spencer Frame, Kelowna (CA); Michelle Brugger, Kelowna (CA)

(73) Assignee: PLANT EPIGENETICS INC., Edmonton (CA)

(21) Appl. No.: 16/538,684

(22) Filed: Aug. 12, 2019

Related U.S. Application Data
(60) Provisional application No. 62/717,329, filed on Aug. 10, 2018.

(51) Int. Cl. A01G 7/04; H05B 33/08

(52) U.S. Cl. CPC A01G 7/045; H05B 33/086; H05B 33/0818; H05B 33/0845

(57) ABSTRACT

A system and method for controlling a light source to stimulate photosynthesis in plants comprises at least one light output device and a processing circuit adapted to cause the at least one light output device to vary at least one of a light composition and light intensity outputted therefrom over time.

### CROSS REFERENCE TO RELATED APPLICATION

This application claims priority to U.S. Provisional Patent Application No. 62/717,329 filed Aug. 10, 2018 entitled Pulsed Lighting Controller.

### BACKGROUND OF THE INVENTION

### 1. Field of Invention

The present invention relates generally to agriculture, horticulture, aquaculture, as well as to indoor gardening, greenhouses, and photosynthetic organisms, and more specifically to artificial lighting control for plant growth.

### 2. Description of Related Art

It is a common understanding that plants use light energy in the process of photosynthesis. It is also known that the light source can be supplied naturally by the sun, or from artificial light sources, as are commonly known. Increasing light wattage, energy, or lux is the best way to increase yield, growth or a desired trait of a plant or photosynthetic organism.

Natural light is known to be the best source for plant growth however the amount of natural light available each day is limited depending upon the location on the earth and time of year. Naturally occurring light is also known to be constantly changing, whereas typical artificial light sources remain at constant energy levels without varying the spectrum composition.

### SUMMARY OF THE INVENTION

According to a first embodiment of the present invention there is disclosed a system for controlling a light source to stimulate photosynthesis in plants comprising at least one light output device and a processing circuit adapted to cause the at least one light output device to vary at least one characteristic of the light outputted by the at least one light output device over time. The at least one light characteristic may be selected from the light wavelength and light intensity.

The processing circuit may be adapted to continuously vary the at least one of light wavelength and light intensity. The processing circuit may be adapted to cause the light output device to vary between an on state and an off state at a set frequency. The set frequency may be at least once every 60 seconds. The on state may be at least 0.001 seconds. The off state may be at least 0.025 seconds. The light wavelength may include visible and UV light wavelengths.

According to a further embodiment of the present invention there is disclosed a system for controlling a light source to stimulate photosynthesis in plants comprising at least one light output device and a processing circuit adapted to cause the at least one light output device to vary at least one of a light composition and light intensity outputted therefrom over time.

The processing circuit may be adapted to continuously vary the at least one of light composition and light intensity. The at least one light output device may be adapted to produce a plurality of light frequency spectrums. The at least one light output device may be adapted to produce pulsed light.

The system may further comprise a plurality of light output devices wherein each of the plurality of light output devices is adapted to produce a distinct light frequency spectrum from each other. The system may further comprise a plurality of the light output devices of each of the light frequency spectrum.

According to a further embodiment of the present invention there is disclosed a method for controlling a light source to stimulate photosynthesis in plants comprising operably connecting at least one light output device to a processing circuit and causing, through the processing circuit, the at least one light output device to vary at least one of a light composition and light intensity outputted therefrom over time.

The processor continuously may vary the at least one of the light comparison and light intensity. The processing circuit may be adapted to cause at least one of the plurality of light output device to vary between an on state and an off state at a pulse frequency. The processing circuit may be adapted to cause the pulse frequency to vary. The set pulse frequency may be at least once every 60 seconds. The on state may be at least 0.001 seconds. The off state may be at least 0.025 seconds.

The at least one light output device may be adapted to produce a plurality of light frequency spectrums. The light wavelength may be selected to include visible and UV light wavelengths. The plurality of light frequency spectrums may comprise at least one constant frequency spectrum and at least one variable frequency spectrum. The at least one variable frequency spectrum may be maintained at a predetermined intensity for a predetermined warm up period after start up. The at least one variable frequency spectrum comprises a pulsed frequency after the warm up period.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a schematic representation of a system for controlling a light source to stimulate photosynthesis in plants according to a first embodiment of the present invention.

FIG. 2 is a block diagram of the controller of the system of FIG. 1.

FIG. 3 is a graphical representation of pulsed light vs. constant light.

FIG. 4a-4f are graphical representations of a sample variation of spectral composition of lighting over time.

FIG. 5 is an illustration of a plurality of light output device according to a further embodiment of the present invention.

FIG. 6 is an illustration of a plurality of light output device according to a further embodiment of the present invention.

FIG. 7 is a graphical representation of a variation of light composition over time according to a further embodiment of the present invention.

### DETAILED DESCRIPTION

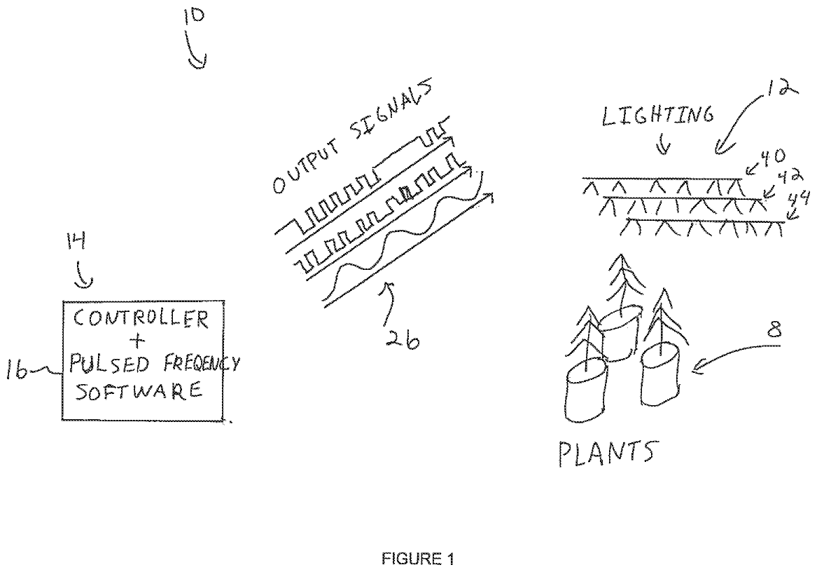

Referring to FIG. 1, a system for controlling at least one light source 12 to stimulate photosynthesis in plants 8 according to a first embodiment of the invention is shown generally at 10. The system 10 comprises a controller 14 having a processing circuit 16 adapted to vary the output of the at least one light source 12 over time. The processing circuit 16 may vary such as, by way of non-limiting example, the light wavelength and light intensity, as will be set out further below.

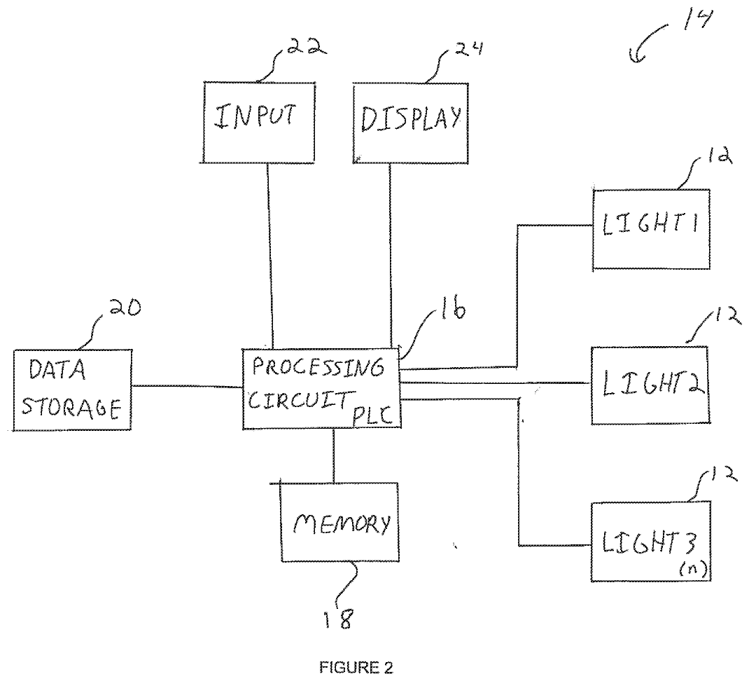

Turning now to FIG. 2, the controller 14 comprises the processing circuit 16, and memory 18 that stores machine instructions that, when executed by the processing circuit 16, cause the processing circuit 16 to perform one or more of the operations and methods described herein. The processing circuit 16 may optionally contain a cache memory unit for temporary local storage of instructions, data, or computer addresses. The controller 14 further includes a data storage 20 of any conventional type operable to store information such as a plurality of light control profiles relating to a variety of plant or photosynthetic organisms to be targeted and may optionally include an input 22 and display 24 for receiving and displaying inputs from an administrator or user. As outlined above, the processing circuit 16 is adapted to vary the output of the at least one light source 12.

More generally, in this specification, the term “processing circuit” is intended to broadly encompass any type of device or combination of devices capable of performing the functions described herein, including (without limitation) other types of microprocessing circuits, microcontrollers, other integrated circuits, other types of circuits or combinations of circuits, logic gates or gate arrays, or programmable devices of any sort, for example, either alone or in combination with other such devices located at the same location or remotely from each other. Additional types of processing circuit(s) will be apparent to those ordinarily skilled in the art upon review of this specification, and substitution of any such other types of processing circuit(s) is considered not to depart from the scope of the present invention as defined herein. In various embodiments, the processing circuit 16 can be implemented as a single-chip, multiple chips and/or other electrical components including one or more integrated circuits and printed circuit boards.

Computer code comprising instructions for the processing circuit(s) to carry out the various embodiments, aspects, features, etc. of the present disclosure may reside in the memory 18. The code may be broken into separate routines, products, etc. to carry forth specific steps disclosed herein. In various embodiments, the processing circuit 16 can be implemented as a single-chip, multiple chips and/or other electrical components including one or more integrated circuits and printed circuit boards. The processing circuit 16 together with a suitable operating system may operate to execute instructions in the form of computer code and produce and use data. By way of example and not by way of limitation, the operating system may be Windows-based, Mac-based, or Unix or Linux-based, among other suitable operating systems. Operating systems are generally well known and will not be described in further detail here.

Memory 18 may include various tangible, non-transitory computer-readable media including Read-Only Memory (ROM) and/or Random-Access Memory (RAM). As is well known in the art, ROM acts to transfer data and instructions uni-directionally to the processing circuit 16, and RAM is used typically to transfer data and instructions in a bi-directional manner. In the various embodiments disclosed herein, RAM includes computer program instructions that when executed by the processing circuit 16 cause the processing circuit 16 to execute the program instructions described in greater detail below. More generally, the term “memory” as used herein encompasses one or more storage mediums and generally provides a place to store computer code (e.g., software and/or firmware) and data. It may comprise, for example, electronic, optical, magnetic, or any other storage or transmission device capable of providing the processing circuit 16 with program instructions. Memory 18 may further include a floppy disk, CD-ROM, DVD, magnetic disk, memory chip, ASIC, FPGA, EEPROM, EPROM, flash memory, optical media, or any other suitable memory from which processing circuit 16 can read instructions in computer programming languages.

Referring back to FIG. 1, the controller 14 is configured to receive an inputted plurality of light control profiles relating to a variety of plant 8 or photosynthetic organisms to be targeted, as set out above, and to generate output signals 26 for controlling each of the at least one light source 12.

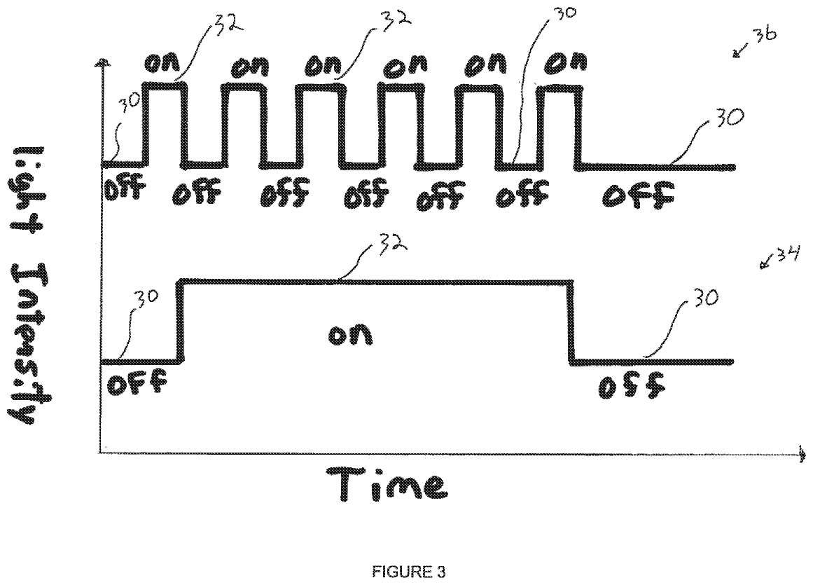

As outlined above, the controller 14 may vary the light intensity of the at least one light source 12. The light intensity may vary between an on state 32 and an off state 30 and may vary in energy output while in the on state 32. As illustrated in FIG. 3, a light source 12 may vary between an off state 30 and an on state 32. Typically, a light source provides constant light, as indicated generally at 34 on FIG. 3. The controller 14 may be configured to provide pulsed light, as indicated generally at 36, where the light source is varied between the on and off states 32 and 30 at a set frequency. As is commonly known, frequency is the number of occurrences of an event over a unit of time, whereas a period is the duration of time for one cycle of a repeating event. As illustrated in FIG. 3, the pulsed light configuration 36 has a high frequency and low period, whereas the constant light configuration 34 has a low frequency and high period. The frequency of the pulsed light configuration may be such as, by way of non-limiting example, at least one on state/off state cycle every 60 seconds. The on state 32 period may be at least 0.001 seconds and the off state 34 period may be at least 0.025 seconds, although other periods may be useful, as well.

A change in environment, such as a pulsing light source 12, causes stress within an exposed plant 8. The desired frequency of pulsing is different depending on the specific plant or photosynthetic organism being targeted, and which nutrient traits or characteristics are being enhanced or changed. As outlined above, the processing circuit 16 may be configured to provide optimal light pulse frequency for a plurality of targeted plants or photosynthetic organisms. Although FIG. 3 illustrates a constant peak frequency in the on state 32, it will be appreciated that the pulse peak may be varied during each pulse on state 32. By varying the pulse peak intensity with each pulse, the light source 12 induces micro stress in the plant 8, mimicking nature's constantly changing environment and increasing plant strength on a cellular level.

In addition to the benefits to plant growth by pulsing the light source, as outlined above, pulsed light requires a supply of electricity only during the on state 32, thereby reducing the overall amount of electricity used over time, when compared to a constant light source. By pulsing the light source, the cost of electricity is reduced.

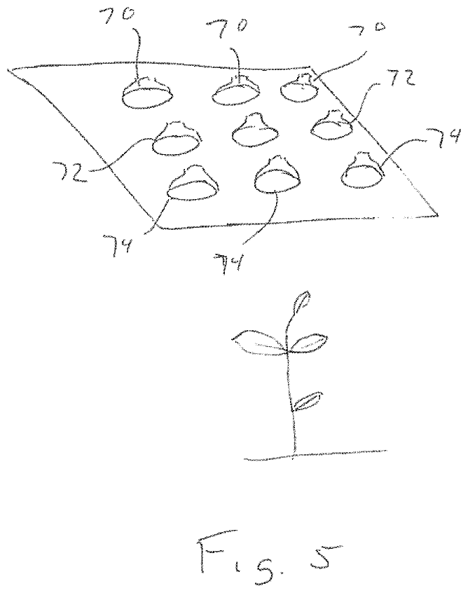

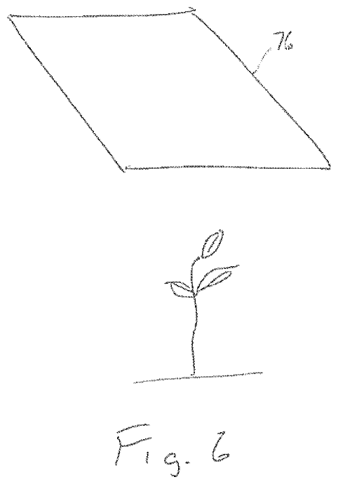

Turning back to FIG. 1, the at least one light source 12 may simultaneously produce a plurality of light spectrums, each spectrum produced by a different wavelength of light, as is commonly known. The at least one light source 12 may include such as, by way of non-limiting example, a blue spectrum 40, a red spectrum 42 and a violet spectrum 44, although other spectrums may be useful as well. The at least one light source 12 may also comprise a variable wavelength light source, as is commonly known. In particular, each individual light source 12 may produce all of the required spectrums or each individual light source may produce a single or lesser subset thereof. Furthermore, it will be appreciated that one or more of each light source type may be utilized. In particular each light source may comprise a light bulb of a particular color as illustrated in FIG. 5, such as, by way of non-limiting example, red 70, blue 72 and green 74 although it will be appreciated that other color spectrums may also be utilized. Alternatively, the light source may comprise a light emitting diode (LED) panel 76 as are commonly known and illustrated in FIG. 6. The light source of each particular or combined light frequency spectrum may also be formed of one or more light bulbs or LED panels of each color wherein the intensity of each light frequency spectrum is adjusted by turning on more or less lights of a particular color or by varying the voltage to the bulbs.

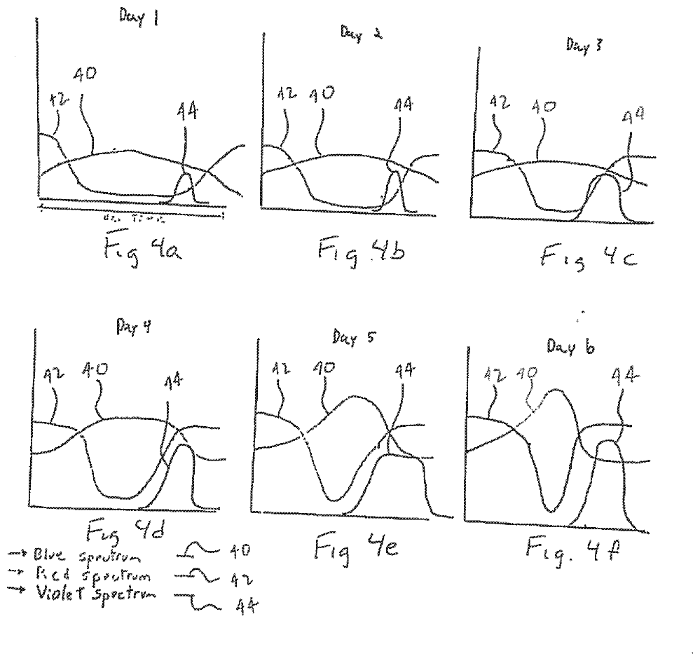

Referring now to FIG. 4a through 4f, sample variations of spectral composition of lighting over time are illustrated. The light intensity of each of the blue spectrum 40, red spectrum 42 and violet spectrum 44 may be controlled by the processing circuit 16 over time, constantly varying throughout each day, hour, minute and second, with each day different from the previous day's cycle and ratio. This constantly changing spectral composition replicates the changing spectral composition of natural light as seasons change between spring, summer and fall. The constant change results in increased growth that is achieved due to the frequency at which the spectral ratio is being fluctuated. In particular:
a first pattern as illustrated in FIG. 4a, may replicate a day from week 1 of flowering;
a second pattern as illustrated in FIG. 4b, may replicate a day from week 2 of flowering;
a third pattern as illustrated in FIG. 4c, may replicate a day from week 3 of flowering;
a fourth pattern as illustrated in FIG. 4d, may replicate a day from week 4 of flowering;
a fifth pattern as illustrated in FIG. 4e, may replicate a day from week 5 of flowering; and
a sixth pattern as illustrated in FIG. 4f, may replicate a day from week 6 of flowering.

The processing circuit 16 may be configured to simultaneously pulse each of the at least one light source 12 between an on state and an off state, as outlined above, as well as to vary the light intensity of each of the plurality of light spectrums. By combining pulsed light with a constantly varying spectral composition, increased plant growth is achieved as well as decreased energy costs.

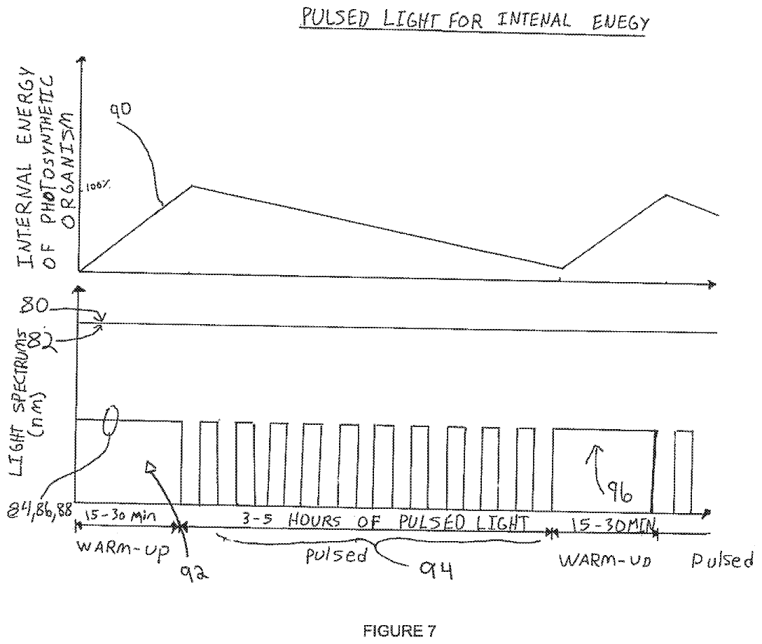

In particular, with reference to FIG. 7, the light provided to the plants may be divided into a plurality of light spectrums such as, by way of non-limiting example, red 80, green 82, violet 84, blue 86 and yellow 88 wherein the red and green 80 and 82 are held on at a constant intensity. In this example, the violet, blue and yellow 84, 86 and 88 are initially held in a constant on status for a warm up period 92. In this warm up period, the energy level 90 provided to the plant will be increased up to a desired level optimal for growth of the plant. After this warm up period, the violet, blue and yellow lights 84, 86 and 88 are then pulsed in a pulse phase generally indicated at 94. It will be appreciated that during this pulsed phase, the energy 90 provided to the plant will decrease until it is no longer in an optimal growth condition at which time the violet, blue and yellow lights 84, 86 and 88 may then be held on constantly again in a maintenance phase 96. Such pulsing of some of the light frequencies will permit reduced electricity consumption. Although the relative pulse levels and frequencies for the violet, blue and yellow lights 84, 86 and 88 are shown as equal in FIG. 7, each of the colors which are varied may have different pulse frequencies and intensities as set out above. By way of non-limited example, it has been found the system utilize, constantly but independently of each other pulsing wavelengths of approximately 280 and 810 nm with always on wavelengths of approximately 520, 532 and 666 nm with the remaining wavelengths of approximately 380, 418, 432, 454, 464, 556, 590, 596, 654 and 699 nm on constantly during the warm up period and pulsed thereafter to simulate a short day. Furthermore, it has been found the system may utilize, a constantly pulsing wavelength of approximately 280 nm with always on wavelengths of approximately 520, 532, 620, 632, 666 nm with the remaining wavelengths of approximately 380, 420, 432, 556, 727, and 740 nm on constantly during the warm up period and pulsed thereafter to for a vegetative program.

In addition to the above frequencies and programs, the present system may be utilized with other light frequencies as well, such as, by way of non-limiting example, ultraviolet (UV) light. In particular, it has been found that through the use of the present system, UV light may be utilized and outputted by the light source 12 with a wavelength of approximately 280 nm which may be pulsed as described above. Such pulsed UV light may be useful in reducing mould and pests in the growing locations and may furthermore be utilized in a constantly on mode to kill all mould and pests from the growing location between crops.

Additionally, it is known that green spectrum has the least impact on plant growth. Therefore through the present system, green color light frequencies such as, by way of non-limiting example, 520 nm may be turned on only when access to the growing location is desired at night.

While specific embodiments of the invention have been described and illustrated, such embodiments should be considered illustrative of the invention only and not as limiting the invention as construed in accordance with the accompanying claims.

What is claimed is:

1. A system for controlling a light source to stimulate photosynthesis in plants comprising:
at least one light output device; and
a processing circuit adapted to cause said at least one light output device to vary at least one of a light composition and light intensity outputted therefrom over time.

2. The system of claim 1 wherein said processing circuit is adapted to continuously vary said at least one of light composition and light intensity.

3. The system of claim 1 wherein said at least one light output device is adapted to produce a plurality of light frequency spectrums.

4. The system of claim 1 wherein said at least one light output device is adapted to produce pulsed light.

5. The system of claim 3 further comprising a plurality of light output devices wherein each of said plurality of light output devices is adapted to produce a distinct frequency spectrum from each other.

6. The system of claim 5 further comprising a plurality of said light output devices of each of said frequency spectrum.

7. A method for controlling a light source to stimulate photosynthesis in plants comprising;
operably connecting at least one light output device to a processing circuit; and
causing, through said processing circuit, said at least one light output device to vary at least one of a light composition and light intensity outputted therefrom over time.

8. The method of claim 7 wherein said processor continuously varies said at least one of said light comparison and light intensity.

9. The method of claim 7 wherein said processing circuit is adapted to cause at least one of said plurality of light output device to vary between an on state and an off state at a pulse frequency.

10. The method of claim 8 wherein said processing circuit is adapted to cause said pulse frequency to vary.

11. The system of claim 8 wherein said set pulse frequency is at least once every 60 seconds.

12. The method of claim 8 wherein said on state is at least 0.001 seconds.

13. The method of claim 8 wherein said off state is at least 0.025 seconds.

14. The method of claim 7 wherein said at least one light output device is adapted to produce a plurality of light frequency spectrums.

15. The method of claim 14 wherein said light wavelength is selected to include visible and UV light wavelengths.

16. The method of claim 14 wherein said plurality of frequency spectrums comprise at least one constant frequency spectrum and at least one variable frequency spectrum.

17. The method of claim 14 wherein said at least one variable frequency spectrum is maintained at a predetermined intensity for a predetermined warm up period after start up.

18. The method of claim 17 wherein said at least one variable frequency spectrum comprises a pulsed frequency after said warm up period.
